(19) United States
(12) Patent Application Publication
(10) Pub. No.: US 2013/0031637 A1
(43) Pub. Date: Jan. 31, 2013

(54) SYSTEM AND METHOD FOR AUTOMATED PROCESSING AND PUBLICATION OF CONTENT

(71) Applicants: Michael A. Avina, Tampa, FL (US); Timothy M. Roberts, Tampa, FL (US)

(72) Inventors: Michael A. Avina, Tampa, FL (US); Timothy M. Roberts, Tampa, FL (US)

(73) Assignee: SAVTIRA CORPORATION, Tampa, FL (US)

(21) Appl. No.: 13/404,745

(22) Filed: Feb. 24, 2012

Related U.S. Application Data
(60) Provisional application No. 61/446,141, filed on Feb. 24, 2011.

(51) Int. Cl. G06F 21/24

(52) U.S. Cl. 726/26

(57) ABSTRACT

The disclosed embodiments relate to a method, an apparatus, and computer-readable medium storing computer-readable instructions for managing publications.

### RELATED APPLICATION DATA

This application claims priority to U.S. Provisional Application No. 61/446,141, filed Feb. 24, 2011, which is hereby incorporated by reference in its entirety.

### BACKGROUND

Modern digital publishing involves numerous complex aspects such as digital rights management (“DRM”), content transferring, publication, security and distribution policies. This provides a significant challenge to both publishers and distributors due to the disconnected and often complex nature of the publication process.

The disclosed embodiment incorporates content policies as a key component. Content, as used herein shall refer to all types of digital media and applications (e.g., video games, music, applications, etc). Content policies, as described, are the policies necessary to determine how a particular unit of content is to be managed. Examples of content policies include such factors as system requirements, install directories, application dependencies, codec requirements, display requirements, sound requirements, operating system requirements, disk available requirements, and any other factor relating to the status of the system as it relates to a particular unit of content.

Typically, the installation of content or applications on a user's computer can involve a great deal of complexity both in terms of requirements but management. The disclosed embodiment seeks to reduce the amount of guess-work by users by incorporating a “wrapper” and a database of content policies. The database of content policies provides the user with immediate feedback as to whether a particular component of content can be used on the user's device. For example, if the user is accessing the content library from a computer desktop, the user might be unable to select certain types of content because the computer desktop does not have the necessary display or memory requirements. In another instance, when accessing a music file from a mobile handset, the user may only be able to receive the music via a stream because the handset lacks the appropriate amount of storage in order to receive the music file. The so-called “wrapper” provides users with another level of service by incorporating both digital rights management, licensing, policy checking and other relevant criteria within a single installation process. Typically, such policies are created manually rather than automatically.

Another aspect relates to updates, hereinafter referred to as “patches”. Patches are updates to an application that enable improvements that the publisher was unable to incorporate within the initial release of a unit of content. Examples of such patches include security updates, driver updates, compatibility updates, etc. The delivery of patches is typically handled through a manual process managed by the users of a particular unit of content. According to the disclosed embodiment, patches are automatically generated and then automatically distributed to the appropriate users. The auto-generation of patches is a significant advancement for both publication and usage of media and applications content.

The disclosed embodiment seeks to reduce the complexity of digital content publication and management by incorporating an automatic DRM wrapper. In this instance, a DRM wrapper refers to a component of software that functions as an adapter between two DRM systems.

### SUMMARY

The disclosed embodiment relates to a publication and management system preferably comprising a database of content, applications, media and other types of digital media, a publication system that provides an interface for publishers to upload digital media and select policies, requirements and patching criteria, a DRM wrapping system that provides an automatic process for processing digital media and auto-incorporating DRM directly into the digital media through an embedding process, a publishing management system that provides an automatic process for generating installation programs complying with policies set by a publisher, a user interface that allows a publisher to establish, update and eliminate policies, and a user interface that allows a publication team to approve content. DRM policies can be modified at any time by the publisher via the publisher's user interface, and patching policies can be modified at any time.

The disclosed embodiment further relates to a method for managing publications. An exemplary method comprises providing an interface for publishers to upload digital media and select policies, requirements and patching criteria, providing an automatic process for processing digital media and auto-incorporating DRM directly into the digital media through an embedding process, providing an automatic process for generating installation programs complying with policies set by a publisher, allowing a publisher to establish, update and eliminate policies, and allowing a publication team to approve content.

In addition, the disclosed embodiment relates to an apparatus for managing publications. An exemplary apparatus comprises one or more processors, and one or more memories operatively coupled to at least one of the one or more processors and containing instructions that, when executed by at least one of the one or more processors, cause at least one of the one or more processors to provide an interface for publishers to upload digital media and select policies, requirements and patching criteria, provide an automatic process for processing digital media and auto-incorporating DRM directly into the digital media through an embedding process, provide an automatic process for generating installation programs complying with policies set by a publisher, allow a publisher to establish, update and eliminate policies, and allow a publication team to approve content.

Moreover, the disclosed embodiment relates to at least one non-transitory computer-readable medium storing computer-readable instructions that, when executed by one or more computing devices, manage publications. Exemplary instructions cause at least one of the one or more computing devices to provide an interface for publishers to upload digital media and select policies, requirements and patching criteria, provide an automatic process for processing digital media and auto-incorporating DRM directly into the digital media through an embedding process, provide an automatic process for generating installation programs complying with policies set by a publisher, allow a publisher to establish, update and eliminate policies, and allow a publication team to approve content.

### BRIEF DESCRIPTION OF THE DRAWINGS

FIG. 1 illustrates an exemplary embodiment in which the publisher or content owner logs into an automated publishing system through a portal over the internet.

FIG. 2 illustrates an exemplary computing device according to the disclosed embodiment.

### DETAILED DESCRIPTION

Automated Publishing System allows publishers or content owners to login to a Web 4.0 GUI front end and setup policies to allow their content to be published, protected, wrapped with an installer builder and then distributed to our content distribution partners whom can sell to consumers to activate the licenses online.

The publisher or content owner logs into our automated publishing system through a user friendly portal overt the internet. The publisher or content owner then creates a profile for the digital content or media. They setup the territories they want a particular SKU sold in and can setup a unique price per currency. The publisher or content owner then choices whether he wants to:

a. Provide the content Already Protected with a DRM
i. They upload keys into our system for sale of the digital assets.
ii. Once the SKU/Profile is completed by the publisher or content owner it is then sent to the Publishing Team for approval for addition to our catalog. Once approved it sends a notice to the publisher the content is now LIVE.
iii. Once this is done the process is completed and the content is then distributed to our distribution partners for addition to their online stores.

b. Or; They elect to use our Automated DRM protection system
i. They setup the polices for the media regarding what protection schema is built around the content or applications ii. They provide the specifics on the application hardware and software dependencies for our automated installer builder.
iii. The media or application is then sent off to the DRM Protection Server for auto-wrapping based on the polices they setup in step (b.)-(i.).
iv. Once the wrapping process is completed it is then sent to the Installer Builder to have a client application installer built around the content or media.
v. Once the SKU/Profile is completed by the publisher or content owner it is then sent to the Publishing Team for approval for addition to our catalog. Once approved it sends a notice to the publisher the content is now LIVE.
vi. Once this is done the process is completed and the content is then distributed to our distribution partners for addition to their online stores.

The system uses a schema which allows for a blended currency exchange rate and also allows the publisher or content owner to view these reports in any currency or language.

They can setup auto-patching and forced patching and upload single patches in order or hotfixes.

They can view reports for:

a. Dashboard data on all transactions

b. Full Analytics and Statistics

c. Financial Data

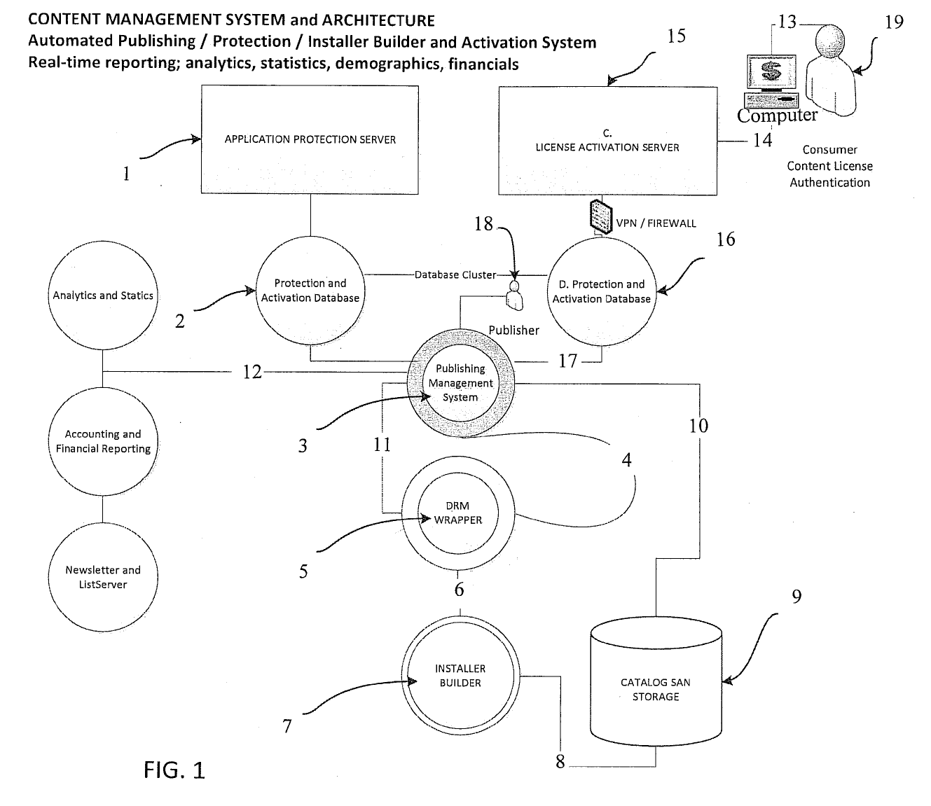

Referring to the diagrams, FIG. 1 represents an embodiment where the publisher or content owner 18 logs into an automated publishing system 3 through a portal over the internet. The publisher 18 then creates a profile for the digital content or media. The publisher 18 then sets up the territories, pricing a currency for a particular SKU.

The publisher 18 chooses whether he wants to provide DRM-protected content. If the content is DRM-protected, the publisher 18 uploads the product keys into our system. The SKU is completed by the publisher or content owner and sent for approval for addition to the catalog 9. An approval notice is sent to the publisher 18 that the content is live. The content is then distributed to distribution partners for addition to their online stores.

In another embodiment, the publisher 18 elects to use the platform's DRM protection system. The publisher 18 provides an application with specifics including the necessary hardware and software dependencies in order to deliver the content or applications. The media or application is then sent to a DRM Server 11 for wrapping using the publisher's 18 content policies. The media or application is then sent to an installer/builder that auto-generates an installation program capable of installing the media or application on a user's 19 computer. The media or content, inclusive of installer and DRM, is then sent to a publication approval team for approval. Upon approval by the publication team, the media or application is then enabled and distributed to distribution partners for addition to their online stores. The system uses a schema which allows for a blended currency exchange rate and also allows the publisher or content owner to view these reports in any currency or language.

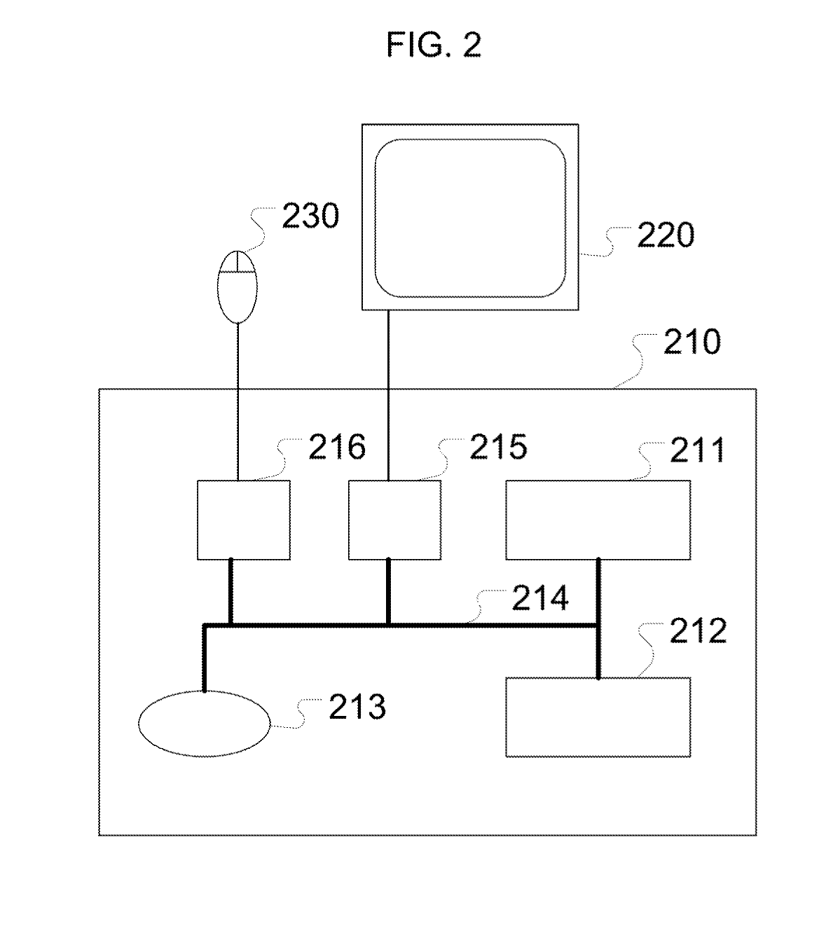

The embodiments described herein may be implemented with any suitable hardware and/or software configuration, including, for example, modules executed on computing devices such as computing device 210 of FIG. 2. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 210 has one or more processing device 211 designed to process instructions, for example computer readable instructions (i.e., code) stored on a storage device 213. By processing instructions, processing device 211 may perform the steps set forth in the methods described herein. Storage device 213 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 210 additionally has memory 212, an input controller 216, and an output controller 215. A bus 214 operatively couples components of computing device 210, including processor 211, memory 212, storage device 213, input controller 216, output controller 215, and any other devices (e.g., network controllers, sound controllers, etc.). Output controller 215 may be operatively coupled (e.g., via a wired or wireless connection) to a display device 220 (e.g., a monitor, television, mobile device screen, touch-display, etc.) In such a fashion that output controller 215 can transform the display on display device 220 (e.g., in response to modules executed). Input controller 216 may be operatively coupled (e.g., via a wired or wireless connection) to input device 230 (e.g., mouse, keyboard, touch-pad, scroll-ball, touch-display, etc.) In such a fashion that input can be received from a user (e.g., a user may input with an input device 230 a dig ticket).

Of course, FIG. 2 illustrates computing device 210, display device 220, and input device 230 as separate devices for ease of identification only. Computing device 210, display device 220, and input device 230 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 210 may be one or more servers, for example a farm of networked servers, a clustered server environment, or a cloud network of computing devices.

While systems and methods are described herein by way of example and embodiments, those skilled in the art recognize that disclosed systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for managing publications, the method comprising:
providing an interface for publishers to upload digital media and select policies, requirements and patching criteria;
providing an automatic process for processing digital media and auto-incorporating DRM directly into the digital media through an embedding process;
providing an automatic process for generating installation programs complying with policies set by a publisher;
allowing a publisher to establish, update and eliminate policies; and
allowing a publication team to approve content.

2. An apparatus for managing publications, the apparatus comprising:
one or more processors; and
one or more memories operatively coupled to at least one of the one or more processors and containing instructions that, when executed by at least one of the one or more processors, cause at least one of the one or more processors to:
provide an interface for publishers to upload digital media and select policies, requirements and patching criteria;
provide an automatic process for processing digital media and auto-incorporating DRM directly into the digital media through an embedding process;
provide an automatic process for generating installation programs complying with policies set by a publisher;
allow a publisher to establish, update and eliminate policies; and
allow a publication team to approve content.

3. At least one non-transitory computer-readable medium storing computer-readable instructions that, when executed by one or more computing devices, manage publications, the instructions causing at least one of the one or more computing devices to:
provide an interface for publishers to upload digital media and select policies, requirements and patching criteria;
provide an automatic process for processing digital media and auto-incorporating DRM directly into the digital media through an embedding process;
provide an automatic process for generating installation programs complying with policies set by a publisher;
allow a publisher to establish, update and eliminate policies; and
allow a publication team to approve content.
